(19) United States
(12) Patent Application Publication
(10) Pub. No.: US 2002/0065787 A1
(43) Pub. Date: May 30, 2002

(54) Relationship-based commerical transaction system and method

(76) Inventors: E. Mark Evers, Lake Oswego, OR (US); Robert G. Gray, Portland, OR (US); Vincent Mangano, North Bend, WA (US)

Correspondence Address: KOLISCH HARTWELL DICKINSON MCCORMACK &, HEUSER, 520 S.W. YAMHILL STREET, SUITE 200, PORTLAND, OR, 97204, US

(21) Appl. No.: 09/939,443

(22) Filed: Aug. 24, 2001

Related U.S. Application Data
(60) Provisional application No. 60/228,108, filed on Aug. 24, 2000.

(51) Int. Cl. G06F 17/60

(52) U.S. Cl. 705/80

(57) ABSTRACT

A computer-and-network based system and method for conducting efficient, third-party-free, direct commercial transactions between qualified purchasers and vendors. Pre-established and pre-agreed-upon relational transactional protocols, which can be selectively revised as necessary by participants, substitute for conventional third-party intermediary activities, such as credit approval and authorization activities.

### CROSS-REFERENCE TO RELATED APPLICATION

This application claims priority to U.S. Provisional Application Serial No. 60/228,108 filed Aug. 24, 2000 titled “An Enhanced Process for the Pricing, Data Capture, Authorization, Communications, Settlement, Funding, and Reconciliation of Commercial Transactions Within the Truck Stop and Fleet Industry.” Attached as Exhibit A to the specification in this case are copies of the disclosure materials contained in this prior provisional patent application.

### BACKGROUND AND SUMMARY OF THE INVENTION

This invention relates to a commercial transaction system and method, and in particular, to such a system and method that avoids normally attendant (conventional) third-party intermediary activities, such as credit authorization and approval activities, by creating and utilizing specific, pre-agreed-upon, purchaser/vendor commercial-transaction relationship protocol implementable over a broad-area communication network, such as the Internet. A preferred embodiment of, and a manner of practicing, the invention are disclosed herein in the setting of commercial trucking operations—an arena in which the invention has been found to offer particular utility.

In an industry, such as the commercial trucking industry, wherein purchases of goods and/or services takes place frequently during a given work day, it is very typical that, with respect to each purchase/sale commercial transaction, such a transaction includes time which is spent in the hands of what are referred to herein as third-party intermediaries, to gain authorization/approval for that transaction. For example, on the occasion, today, of a commercial truck driver stopping at some site, say a truck stop site, and there seeking to purchase fuel, a new tire or other things or services, each such transaction is accompanied by something like a purchase approval activity, if not specifically that, involving third party intermediaries, such as a credit-extending intermediary. Very clearly, this presence of third-party intermediary activity adds appreciable time to a transaction, and over a longer span of time during which there may be multiple transactions conducted, the accumulated amount of time spent with respect to such third-party intermediary activity can become quite significant, and can diminish appreciably the efficiency and cost-effectiveness of the work being performed by a driver purchaser. Additionally, the overall extra time spent in the realm of transaction approvals and has the effect of reducing a driver's productivity and/or personal income generation.

The present invention addresses this issue by implementing a commercial transaction system and method which, effectively, substantially completely eliminates per-transaction approval/authorization activities. It does so very specifically by establishing participating groups of vendors of goods and services, and of purchasers for the same, and by pre-qualifying the respective members of these groups to establish pre-approved, pre-authorized commercial transaction protocols between specific vendors and specific purchasers. These protocols obviate the need for, and therefore can substantially eliminate, the kind of third party intermediary activities mentioned above. In effect, what the system and method of the present invention do is replace third-party intermediary approval and authorization activities by pre-established and pre-agreed upon transactional relationships between vendors and purchasers.

Various other features of the invention, and advantages offered by it, will become more fully apparent as the description which now follows is read in conjunction with the accompanying drawings.

### DESCRIPTION OF THE DRAWINGS

FIG. 1 is a simplified, block/schematic, visual representation of a typical prior art vendor/purchaser transaction which includes third-party intermediary activity that is substantially eliminated by the present invention.

FIG. 2 is a simplified, block/schematic diagram illustrating, for a single purchaser and single vendor, and visually, the structure and operation of the system and method of the present invention.

FIG. 3 is a more detailed (plural purchaser, plural vendor) elaboration of the system and method illustrated in FIG. 2.

FIG. 4 is a block/flow diagram generally illustrating the architecture of activities employed in setting up and using the system and method of the present invention.

FIG. 5 is a view illustrating schematically, on its left side, a string of conventional transactions performed by an individual truck driver over the span of a single unit of time, such as a day of work, and on its right side, that same string of “work day” transactions depicted in the setting of the system and method of the present invention.

### DETAILED DESCRIPTION OF THE INVENTION

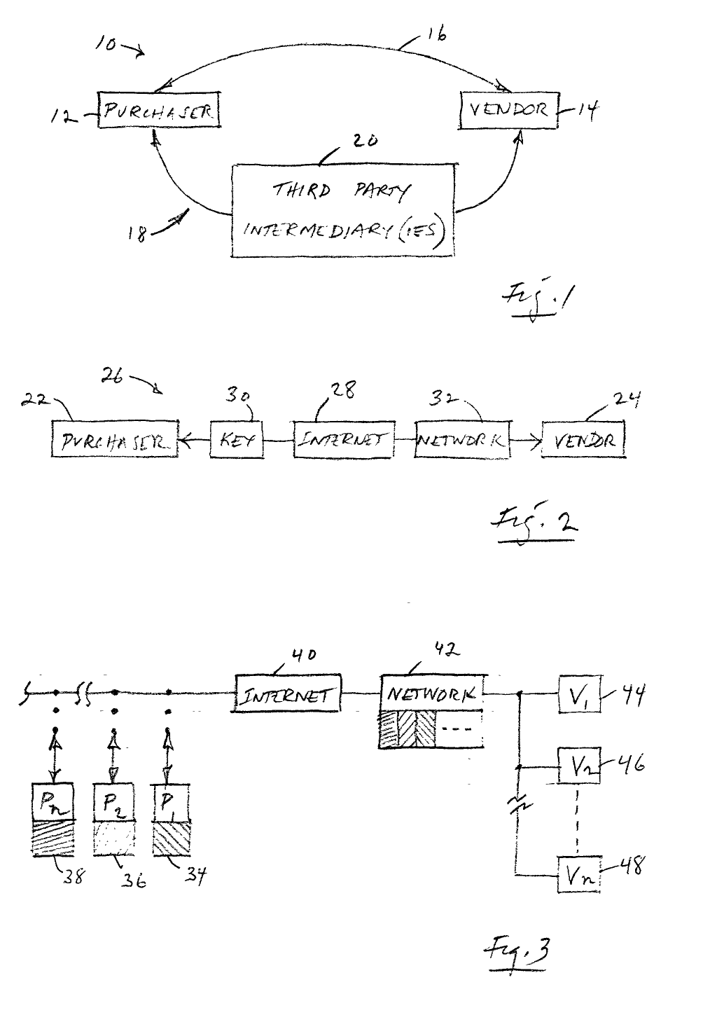

Turning now to the drawings, and referring first of all to FIG. 1, indicated generally at 10 is a schematic representation of a conventional, prior art purchaser/vendor commercial transaction. In this figure, the purchaser is represented by block 12 and the vendor by block 14.

Extending operatively between purchaser 12 and vendor 14 are two transactional paths 16, 18 that generally describe the presence of activities associated with the transaction pictured in FIG. 1. Path 16, which is represented by a single, curved double-ended arrow, relates to the requesting, and the resulting fulfillment, for and of services and/or goods between purchaser 12 and vendor 14. Path 18 includes a block 20 which represents activities performed by one or more third party intermediary(ies). This path, i.e., path 18, reflects, as an illustration, third-party approval and authorization activity associated with the particular transaction pictured in FIG. 1. Such third-party activity relates to “qualifying” purchaser 12 for completion of the transaction between vendor 14 and purchaser 12. In a very typical case, the activities which take place at the hands of third parties involve a kind of credit approval and authorization activity. FIG. 1 essentially diagrams the architecture of a conventional purchaser/vendor transaction where payments are made through credit-granting intermediaries.

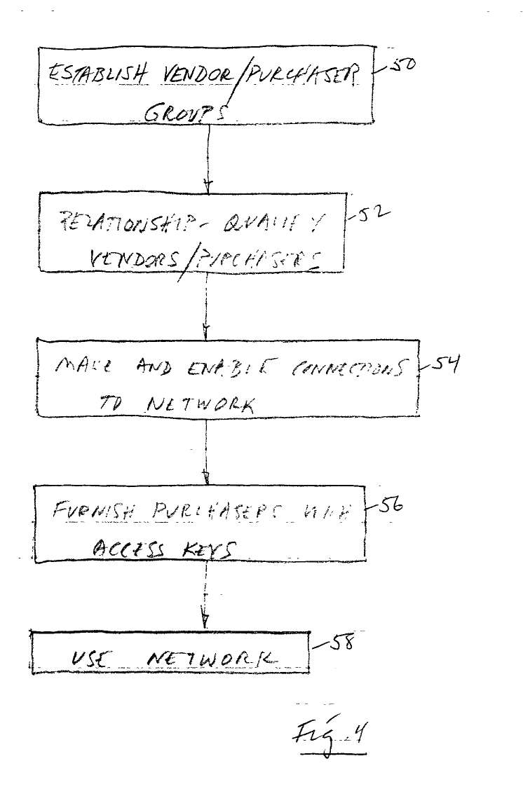

FIG. 2 illustrates, as between a single purchaser 22 and a single vendor 24, a commercial transaction 26 that is performed in accordance with practice of the present invention. Both the transaction pictured in FIG. 2 and that pictured in FIG. 1 take place, as disclosed herein, over a broad-area, information-exchange network, such as the Internet.

The Internet is not specifically pictured in FIG. 1, but it is so pictured in FIG. 2 by a block 28 which sits, as pictured in FIG. 2, generally centrally along a single transaction path that extends between purchaser 22 and vendor 24. While the Internet is disclosed herein as a convenient communication medium between a purchaser and a vendor, it should be understood that other kinds of information-exchange networks could also be used.

Further included in the single path of activity illustrated in FIG. 2 between purchaser 22 and vendor 24 are blocks 30, 32 which represent, respectively, a personalized system access key, or appliance, which is carried by purchaser 22, and a system or network database that, according to the invention, describes pre-established and pre-approved commercial relationship protocols between participating purchasers and vendors, such as purchaser 22 and vendor 24. It is important to note in FIG. 2 that there is no lateral or secondary branch of activity that occurs between purchaser 22 and vendor 24, such as the branch of activity represented by path 18 in FIG. 1. Third-party intermediary participation is totally absent from the transaction pictured in FIG. 2.

With respect to the specific single transaction illustrated in FIG. 2, purchaser 22, employing access key 30 and Internet 28, places an order through network 32 to vendor 24—all done very directly between the purchaser and the vendor. Key 30 and network database 32 cooperate over Internet 28 to implement immediately the pre-agreed upon commercial transactional protocol that is permitted between purchaser 22 and vendor 24. This implementation promotes rapid and efficient completion of transaction 26 between these two parties, without there being required or present any specific independent activity approval by third-party intermediaries. Transaction 26 is, therefore, in most instances, significantly faster and more efficient than the transaction 10 pictured in FIG. 1.

Turning attention now to FIG. 3, here, shown by blocks 34, 36, 38 are three purchasers, labeled P₁, P₂ and Pₙ. Double-ended arrows, and rows of dots, at the left side of FIG. 3 represent respective connectivities that are made possible for these three purchasers through the Internet, which is shown in FIG. 3 by block 40, to network database 42 (which is the same as block 32 in FIG. 2). At the lower portions of blocks 34, 36, 38, there are shown three different shaded rectangles, shaded differently to represent personalized purchaser-carried system-access keys, or appliances, that contain appropriate identifying data which indicates that these respective purchasers are in possession of pre-approved commercial transaction protocols with selected vendors who are participants in the system of the invention. Three different kinds of shading are shown for these three purchaser-representing blocks to indicate that the approved transaction protocols for each of the three purchasers pictured in FIG. 3 is different from that approved for and in place relative to the other two purchasers shown in FIG. 3.

Block 42 in FIG. 3, as was generally indicated above, is a database which contains information regarding the respective commercial transaction protocols that have been pre-approved between each one of purchasers 34, 36, 38 and different ones of the three vendors shown in block form at 44, 46, 48 at the right side in FIG. 3. Blocks 44, 46, 48 carry the legends V₁, V₂ and Vₙ.

Pictured within block 42 is an internal region which contains three sub-blocks that are shaded in the same manners shown for the purchaser blocks in FIG. 3. These three shadings essentially, on a one-to-one basis, duplicate the respective key-access shadings pictured for the purchasers in blocks 34, 36, 38. The small rectangle in block 42 which displays dashes represents the general open-endedness of this invention to accommodate many purchasers and vendors.

For the purpose of illustration herein, let us assume that purchaser 34 has associated with it, him or her pre-approved transactional protocols with vendors 44, 46, that purchaser 36 has the same kind of relationship established with vendors 44, 48, and that purchaser 38 has essentially the same kind of pre-agreed-upon relationship established with vendors 46, 48. When each of these respective different purchasers wishes to conduct a transaction with an associated-relationship vendor, the purchaser utilizes the associated specific key-access tool which is provided in accordance with this invention, which tool might be something like a personal pocket-sized computer access tool, to make a working connection at any appropriate site, such as the site of a truck stop to Internet 40 and database 42. The purchaser places an order with one or more of the pre-approved vendors, is quickly confirmed as one with whom a specific requested commercial transaction should take place, and receives a quick, appropriate fulfillment of a placed order for goods or services. No separate third-party intermediary activity is involved in any way with implementing and completing such a transaction.

The same kind of operational possibility is made available to each and every other one of the purchasers, like purchasers 36, 38, who have been qualified for participation in the system and method of this invention.

To describe more specifically how a transaction according to this invention might take place, a truck driver, during his daily flow of work, stops at a truck stop and places an order, effectively, for fuel, and for a new tire. This is done by that driver employing the provided personalized access key to make a connection through the Internet and the system database to the one or more selected vendors for these goods. The pre-approved transaction protocol that relates this purchaser with those vendors quickly enables appropriate fulfillment of the requests for goods. And so, at the truck stop site mentioned, the truck stop operator, without awaiting any approval or authorization activity from any third-party vendor, supplies fuel and a new tire as requested to the purchaser. Transaction proceeds rapidly, and without any block of time committed to third-party participation/intervention.

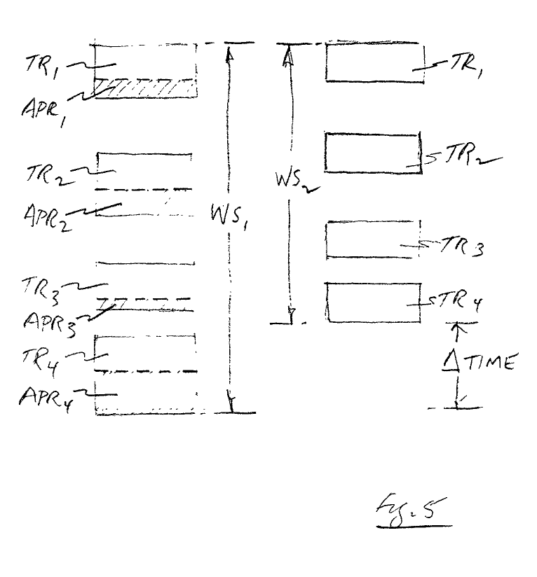

FIG. 4, in five different chain-link blocks, 50, 52, 54, 56, 58, are pictured in a vertical stack to describe generally how the system and method the present invention are set up for use by participating purchasers and vendors.

Block 50 represents the open-ended establishment of groups of participating vendors and purchasers. Block 52, with respect to the groups established in block 50, represents the activity of creating relationship qualifications between each purchaser and selected ones of the participating vendors with whom the purchaser is expected to seek commercial transactions. This relationship-qualification activity effectively defines the nature of the various commercial transactions which are to become pre-approved between the associated purchaser and vendors, and to become part of the operating database (see block 32 in FIG. 2 and block 42 in FIG. 3) of the system. This activity in block 52 effectively results in a substitution, for conventional third-party intermediary approval and authorization activity, of pre-approved commercial protocol relationships between vendors and purchasers.

Block 54 represents the act of connecting participating vendors to the system of the present invention via a medium, such as the Internet, and the enabling of selective, like connections for purchasers.

Block 56 represents the furnishing to each participating purchaser of an access appliance or key device which contains information that identifies that party as a participating purchaser, and that also either contains directly, or otherwise, pointers to the specific relationship database that is relevant to that particular purchaser. As was mentioned earlier herein, the access key or appliance can be any suitable device, such as a pocket personal computing device, a cellular phone with an appropriate internal purchaser-specific identifying database, smart card, radio frequency identification tag or other.

Block 58 represents use by participating purchasers and vendors of the system and method of this invention for commercial transactions.

As will be completely apparent to those skilled in the art, implementation of the system and method of the present invention takes place in the realm of computers.

There is thus proposed a novel system and method which effectively completely eliminates from vendor/purchaser transactions, the lateral activities conventionally performed by various third-party intermediaries, such as credit-associated intermediaries. Pre-established relationships for authorized commercial transactions between purchasers and vendors become efficient substitutes for such conventional third-party activities. Specific transactions which occur between a purchaser and a vendor are handled with great speed and efficiency.

In the setting of commercial trucking, where it is very much the usual case that a truck driver may make a number of different purchase requests during a given working day, because of the fact that the system and method of this invention effectively eliminate third-party activities like those represented by path 18 in FIG. 1, the respective amounts of time that would otherwise be associated with each individual transaction in a string of transactions during a day are eliminated. FIG. 5 helps to illustrate this situation, wherein, on its left side four successive commercial transactions, TR₁, TR₂, TR₃ and TR₄, which are associated, respectively, with related third-party approval and authorization activities, APR₁, APR₂, APR₃ and APR₄, are presented to define an overall work span, WS₁. These “left-side” activities are compared, on the right side of FIG. 5, with fundamentally the very same transactions, but without any associated third-party approval activities like those shown on the left side of the figure. The absence of per-transaction-specific approval activities, each of which requires independent time (represented as a vertical dimension in FIG. 5) means that these four transactions can actually take place during an overall work span WS₂ which is considerably shorter than WS, by the amount represented in FIG. 5 as Δ TIME.

This comparison handily shows and suggests the kinds of improved efficiencies that are offered by practice of the present invention. For example, the same transactions can be performed over a much shorter period of time, and can thus leave room for a purchaser to perform additional transactions (within a given overall period of time) that could not be performed in that same period of time where conventional third-party intermediary approval and authorization activities must also take place on a transaction-to-transaction basis. Time not spent managing traditional third-party activities in relation to transactions benefits, for example, other people and organizations, such as truck stops. The less time required for completion of a transaction the more economical becomes the entire practice of transaction fulfillment for just about all involved parties. For example, in the case of truck-stop operations, more “throughput” is made possible.

The specific algorithms which one chooses to use in a computer-based system to implement the system and method of this invention are numerous, and form no particular part of the present invention. Thus are not disclosed herein in any detail. And, while the system and method of this invention have been discussed and disclosed herein specifically in the setting, for illustration, of commercial trucking, it is appreciated that other fields of commercial transactions could benefit as well from use of the invention.

While the invention has been disclosed in a particular setting in a preferred form herein, the specific embodiments thereof as disclosed and illustrated herein are not to be considered in a limiting sense. Numerous variations, some of which have been shown and discussed, are possible. Applicant regards the subject matter of his invention to include all novel and non-obvious combinations and subcombinations of the various elements, features, functions and/or properties disclosed herein. No single feature, function, element or property of the disclosed embodiments is essential. The following claims define certain combinations and subcombinations which are regarded as useful, novel and non-obvious. Other such combinations and subcombinations of features, functions, elements and/or properties may be claimed through amendment of the present claims or through presentation of new claims in this or in a related application. Such amended and/or new claims, whether they are broader, narrower or equal in scope to the originally presented claims, are also regarded as included within the subject matter of applicant's invention.

[image]

[image]

[image]

[image]

[image]

[image]

[image]

[image]

[image]

[image]

From the foregoing, one can see that the present invention generally involves the steps of (1), establishing, at a remote site, a user-accessible, common, computer-based source that promotes direct connectivity and commercial engagement by a user with plural, diverse, potential suppliers of generally site-character-specific, user-requested goods and/or services, and as a part of that establishing activity, creating selected, pre-established, commercial-transaction protocols, (2), enabling, at and via that very same site, and through the use of a user-carried, computer-related communication device, plural-user communications and transactions between a user and one or more of such suppliers, and (3), on the basis of that enabling activity, promoting the on-site delivery of at least certain, selected, user-requested ones of such goods and/or services.

Another way of describing the operation of the system of this invention is that it involves: (a), establishing, within a computer-accessible host environment, a collection of enrollee providers of site-specific goods and services; (b), with respect to that collection, mapping to plural, selected, remote requestor sites selected provider-specific access interfaces that are associated, and that enable communication, with selected providers in the collection, which selected providers are commercially engaged with respective goods and/or services that are specific to such respective requestor sites, and wherein each interface is selectively, changeably configurable to define specific, user-enrollee communication protocols; and (c), providing computer-employable, information-communication linkage appropriately between the host environment and the different requester sites, and equipping potential requesting users, who may be present at different times at different ones of such requester sites, with a computer-communication-enabled tool which is capable of connecting via each such requestor site to the host environment, thus to establish, via activity at that requester site, request-response communication between such a user and an enrollee provider.

This kind of operational behavior is made possible in the commercial transaction exchange system of the present invention by virtue of the fact that that system includes (1), a host environment which has dominion over requestable supplies of information, services, products, etc., and which is made up from a population of diverse host enrollees, (2), at least one remote requestor-access site which has pre-established communication connectivity linking it with the host environment, and effectively being postured (the site) with pre-established, request-enabling commercial-transaction parameters which have been established a priori with enrollees at the host environment, and (3), a user-carried request-communication tool which is operatively connectable at the requestor-access site for effective, direct communication via that site with enrollees that make up the host environment, all for the purpose of establishing and fulfilling a commercial transaction between a requesting user and a host enrollee.

Effectively, the system of the present invention creates at one or more remote sites, a site-specific virtual shopping mall which is directly connected for communication with a plurality of diverse suppliers of goods and services who have enrolled to become part of the system. The enrolled status of these providers is such that pre-defined transaction protocols are typically already in place in relation to the ways in which the user sites respond to a specific request from a requesting user. This arrangement effectively eliminates the mid-region of transaction behavior which is now customary—typically involving the communication of requests, information, etc. through personnel that are present normally at the site, such as the site of a truck stop. The system effectively eliminates the intermediary activities currently engaged in by personnel at such a site.

A further important facet of the present invention is that the above-described “exchange” (system) environment accommodates and promotes interaction between different enrollees to establish, selectively, flexibly, and completely at will, many desirable commercial aspects of dealings between enrollees themselves, and between enrollees and requesters, such as prices, credit arrangements, allotments, reverse-auction protocols, and others.

[image]

[image]

[image]

[image]

[image]

[image]

[image]

[image]

[image]

[image]

We claim:

1. A non-third-party, purchaser/vendor exclusive commercial transaction method, wherein traditional third-party participation is absent and fully replaced by specific patterns of commercial relationships which have been pre-developed and pre-qualified between purchaser/vendor users of the method, and which method is designed for practice in conjunction with a computer-based, broad-area, information-exchange network, said method comprising
establishing a participating group of vendors of products and/or services, qualifying vendors in the group, and connecting this group to such a network,
establishing a participating group of purchasers of such products and/or services and qualifying these purchasers,
creating for each purchaser, and based upon the above-recited qualifying activities, a personal package of pre-agreed upon, developed and qualified commercial relationships in the forms of data specially associating that purchaser with selected ones of such vendors, and
furnishing each purchaser with a personal network-access key which contains information fully allowing that purchaser, through connection with the network, to utilize the mentioned package of relationships associated with that purchaser and the selected vendors.

2. The method of claim 1 which is specifically designed for use in association with the field of commercial trucking activities.

3. The method of claims 1 or 2 which further comprises enabling participating vendors to revise their respective qualifications for participation.

4. The method of claims 1 or 2 which further comprises enabling participating purchasers to revise their respective qualifications for participation.

5. Establishing an open-ended group of network participants, including plural vendors and plural purchasers of various products and/or services,
pre-qualifying such participants for use of the network by creating, with respect to each purchaser and to a selected plurality of associated vendors with whom the purchaser may wish to engage in commercial transactions, a set of specific, agreed-upon commercialize-relationship protocols, which set may differ from a like set created for other purchasers and associated vendors,
connecting the vendors to the network,
enabling such a connection for the purchasers, and
furnishing each purchaser with a purchaser-specific, network-access, portable appliance key which allows that purchaser selectively to connect and disconnect from the network, and which contains a network-communicable database which allows utilization by a connected purchaser of the specific set of protocols defined for and associated with that purchaser and with the selected associated vendors,
wherein a connection made by a purchaser to the network using the appliance key enables a direct commercial, transactional link between the purchaser and each vendor associated with the protocol set created for that purchaser, each of which links allows for a direct purchaser/vendor commercial transaction over the network without there occurring any associated, participating, branching outside of the link to include any third-party transaction activity.

6. The method of claim 5, which is specifically designed for use in association with the field of commercial trucking activities.

7. A non-third-party, purchaser/vendor specific, commercial transaction system, wherein third-party participation is absent, and fully replaced by specific patterns of commercial relationships which have been pre-developed and pre-qualified between users of the system, and which system is designed for practice in conjunction with a computer-based, broad-area, information-exchange network, said system comprising
a computer-accessible database relating to participating vendors of products and/or services appropriately connected to such a network,
a computer-accessible database relating to participating purchasers of such products and/or services and appropriately connectable to such a network, and
a key access tool providable to purchasers and connectable to such a network for identifying a particular purchaser to the network, and for accessing, within the network, pre-agreed upon, commercial-transaction protocols established for each purchaser and selected vendors,
connection by a purchaser through the associated key access tool to the network enabling a direct commercial, transactional link between that purchaser and each vendor associated with the specific purchaser through the pre-agreed-upon protocols, whereby a direct purchaser/vendor commercial transaction over the network takes place without there occurring any associated, participating, branching outside to include any third-party transaction activity.

8. A computer and network-based commercial transaction method employed between participating vendors and purchasers of various goods and/or services, wherein there has been established, between such vendors and purchasers, specific patterns of pre-agreed upon commercial transactional relationships, and the participating purchasers are engaged in work spans of time characterized by plural, successive requests for such goods and/or services, said method comprising
furnishing a vendor-/purchaser-accessible communication network poised to implement such relationship patterns,
enabling commercial transactional connections over the network between participating vendors and purchasers, and
as an outcome of said enabling, and over a defined span of time, promoting the realization of plural successive transactions between a participating vendor and a participating purchaser, which transactions take place, one after another, without the expenditure of time during that span to conduct per-transaction, lateral transaction approvals and/or authorizations.
